(19) United States
(12) Patent Application Publication
(10) Pub. No.: US 2026/0135054 A1
(43) Pub. Date: May 14, 2026

(54) Relay Coil Assembly and Relay

(71) Applicant: Tyco Electronics Technology (SIP) Co., Ltd., Suzhou (CN)

(72) Inventors: Feng (Cathy) Chen, Suzhou (CN); Quarry (Bingfeng) Qu, Suzhou (CN); Zengping Jin, Suzhou (CN)

(73) Assignee: Tyco Electronics Technology (SIP) Co., Ltd., Suzhou (CN)

(21) Appl. No.: 19/387,926

(22) Filed: Nov. 13, 2025

(30) Foreign Application Priority Data
Nov. 13, 2024 (CN) 202422769493.7

(51) Int. Cl. H01H 50/44; H01F 27/32; H01H 50/02; H01H 50/14

(52) U.S. Cl. CPC H01H 50/44; H01F 27/32; H01H 50/02; H01H 50/14

(57) ABSTRACT

A relay coil assembly includes a coil skeleton, a coil and a first insulation tape. The coil skeleton has an upper flange, a lower flange and a cylindrical portion located between the upper flange and the lower flange. The coil is wound around the cylindrical portion of the coil skeleton. The first insulation tape is wrapped and bonded to the outer peripheral surfaces of the upper flange and the lower flange. The coil skeleton is located in a space surrounded by the first insulation tape. The coil is sealed in an annular enclosed space defined by the first insulation tape and the coil skeleton.

### CROSS-REFERENCE TO RELATED APPLICATION

This application claims the benefit of Chinese Patent Application No. CN202422769493.7 filed on Nov. 13, 2024 in the State Intellectual Property Office of China, the whole disclosure of which is incorporated herein by reference.

### FIELD OF THE INVENTION

The disclosure relates to a relay coil assembly and a relay comprising the relay coil assembly.

### BACKGROUND OF THE INVENTION

In the prior art, a relay typically includes an outer insulation shell, a metal shell, an inner insulation shell, an insulation cover, a pair of static terminals, a movable terminal, a relay coil assembly, a magnetic plate and a drive assembly. The metal shell is set in the outer insulation shell. The inner insulation shell is set in the metal shell. The insulation cover is installed into the top opening of the outer insulation shell. A pair of static terminals are fixed to the insulation cover and extend into the inner insulation shell. The movable terminal is set in the inner insulation shell and can move between a closed position in electrical contact with a pair of static terminals and an open position in electrical separation from the pair of static terminals. The Relay coil assembly is set in a metal shell. The relay coil assembly includes a coil skeleton and a coil wound around the coil skeleton. The magnetic plate is supported on the top surface of the coil skeleton. The drive assembly includes a drive shaft, an insulation base, a limit bracket, a contact spring, a reset spring, and a movable magnetic core. The upper end of the drive shaft is fixed to the insulation base, the limit bracket is fixed to the insulation base, the movable terminal is installed in the limit bracket, and the contact spring is compressed between the movable terminal and the insulation base. The movable magnetic core is set in the coil skeleton, and the lower end of the drive shaft is fixed to the movable magnetic core to move axially together with it. The reset spring is compressed between the magnetic plate and the movable magnetic core.

The coil of the relay is used to connect with a low-voltage control circuit. The static and movable terminals of the relay are used to connect with a high-voltage load circuit. The insulation base electrically isolates the high-voltage components of the relay (such as static terminals, movable terminal, limit bracket, and metal shell) from the drive shaft and the magnetic plate to achieve electrical isolation between the high-voltage components and the low-voltage components (such as coil) of the relay. However, this electrical isolation scheme has a complex structure and a high cost.

### SUMMARY OF THE INVENTION

According to an embodiment of the present disclosure, a relay coil assembly includes a coil skeleton, a coil and a first insulation tape. The coil skeleton has an upper flange, a lower flange and a cylindrical portion located between the upper flange and the lower flange. The coil is wound around the cylindrical portion of the coil skeleton. The first insulation tape is wrapped and bonded to the outer peripheral surfaces of the upper flange and the lower flange. The coil skeleton is located in a space surrounded by the first insulation tape. The coil is sealed in an annular enclosed space defined by the first insulation tape and the coil skeleton.

### BRIEF DESCRIPTION OF DRAWINGS

The above and other features of the present invention will become more apparent by describing in detail exemplary embodiments thereof with reference to the accompanying drawings, in which:

FIG. 1 shows an illustrative perspective view of a relay according to an exemplary embodiment of the present invention;

FIG. 2 shows a cross-sectional view of a relay according to an exemplary embodiment of the present invention;

FIG. 3 shows an illustrative perspective view of a relay coil assembly of a relay according to an exemplary embodiment of the present invention;

FIG. 4 shows an illustrative exploded view of the relay coil assembly of a relay according to an exemplary embodiment of the present invention;

FIG. 5 shows an illustrative exploded view of the relay coil assembly of a relay according to an exemplary embodiment of the present invention;

FIG. 6 shows an illustrative exploded view of the relay coil assembly of a relay according to an exemplary embodiment of the present invention;

FIG. 7 shows a cross-sectional view of a relay coil assembly of a relay according to an exemplary embodiment of the present invention;

FIG. 8 shows a plan sectional view of a relay coil assembly of a relay according to an exemplary embodiment of the present invention; and

FIG. 9 shows a plan sectional view of a relay coil assembly of a relay according to another exemplary embodiment of the present invention.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a relay coil assembly comprises: a coil skeleton comprising an upper flange, a lower flange, and a cylindrical portion located between the upper flange and the lower flange; a coil wound around the cylindrical portion of the coil skeleton; and a first insulation tape which is wrapped and bonded to the outer peripheral surfaces of the upper flange and the lower flange. The coil skeleton is located in a space surrounded by the first insulation tape, and the coil is sealed in an annular enclosed space defined by the first insulation tape and the coil skeleton.

According to another embodiment, a relay comprises: a metal shell; the above relay coil assembly arranged in the metal shell; and a magnetic plate which is installed in the metal shell and supported on the top surface of the upper flange of the coil skeleton. The outer peripheral surface of the magnetic plate is in electrical contact with the inner peripheral surface of the metal shell, and the first insulation tape electrically isolates the coil skeleton from the metal shell.

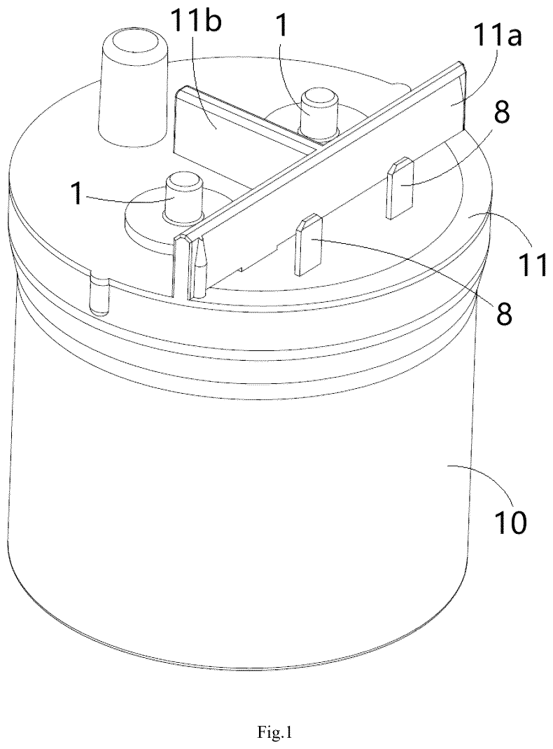

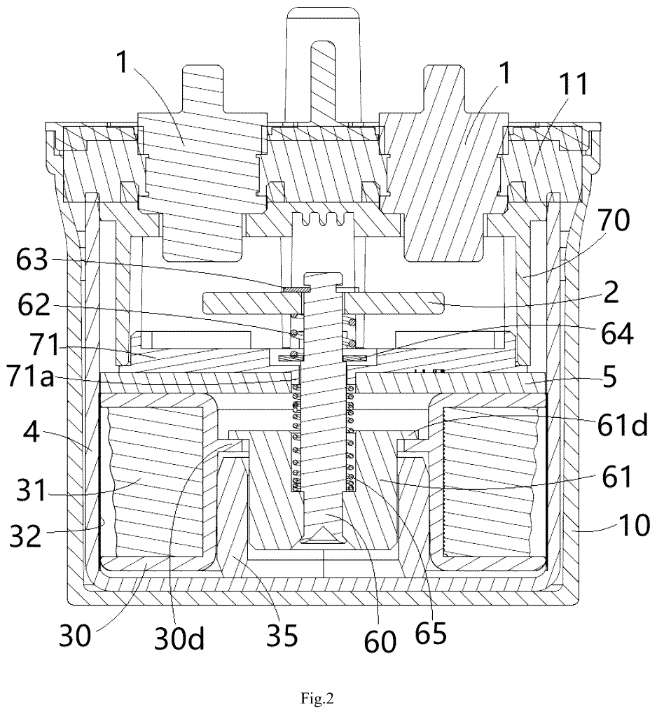

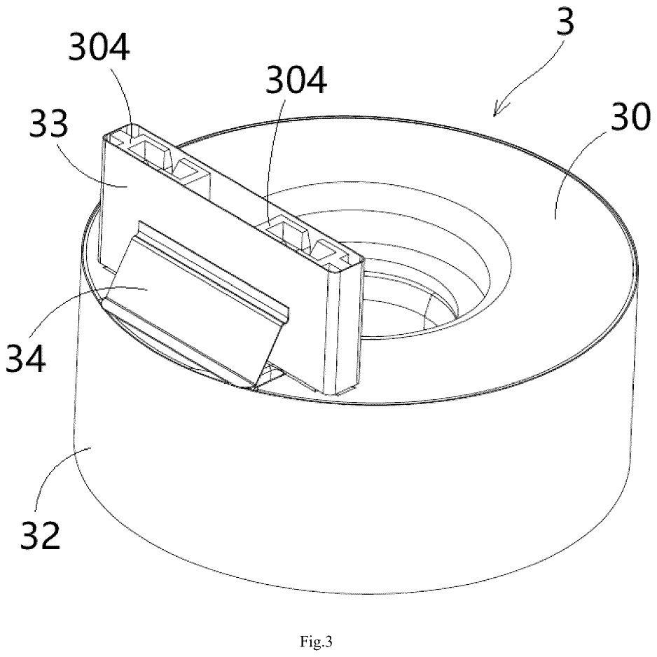

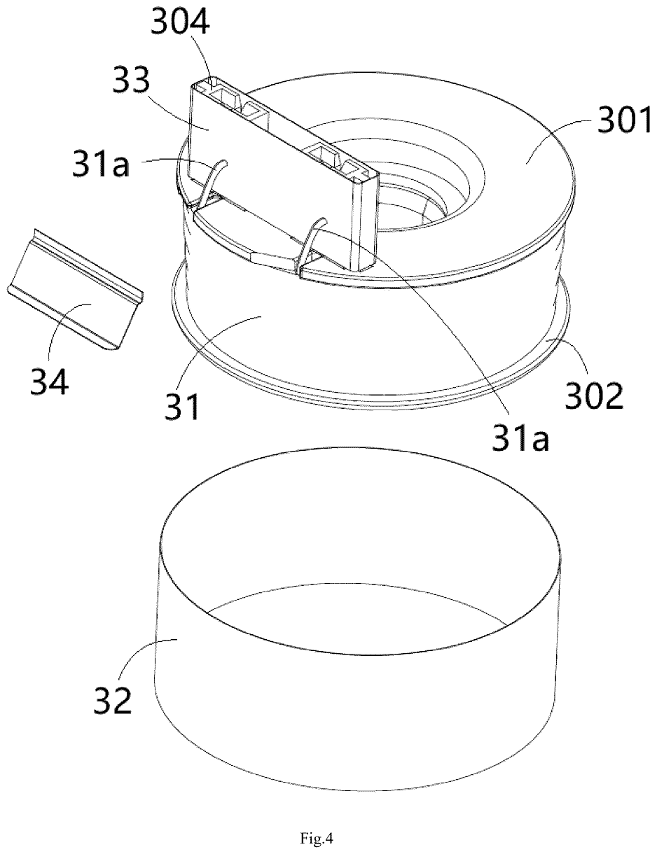

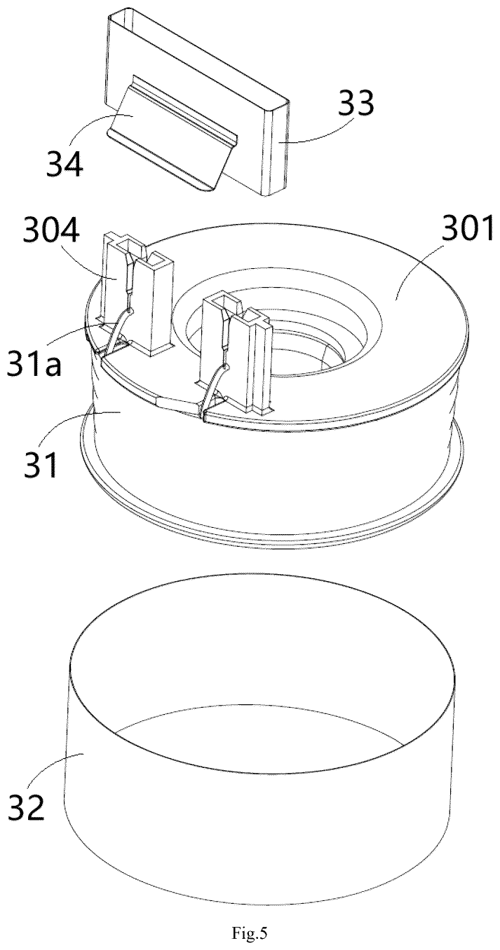

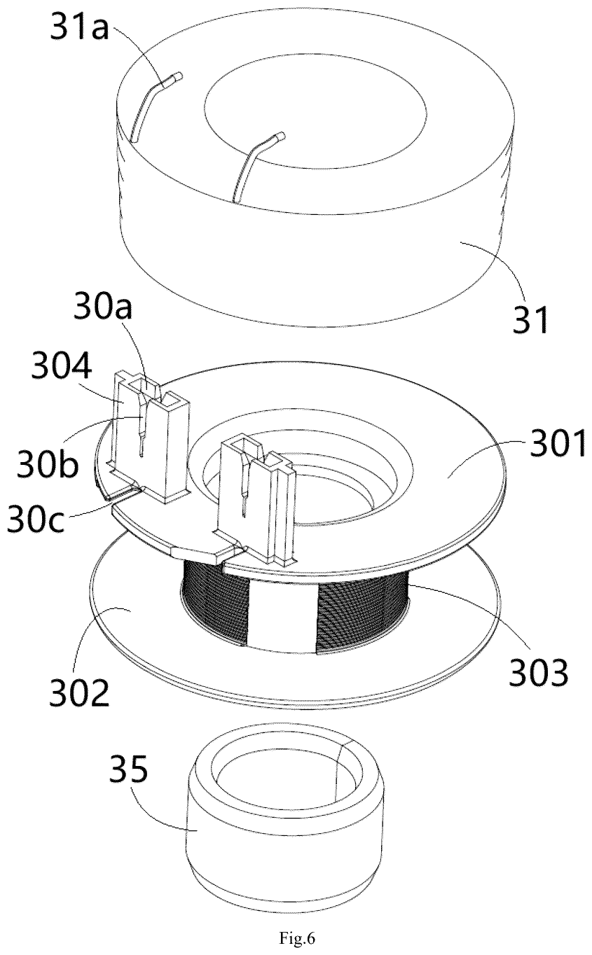

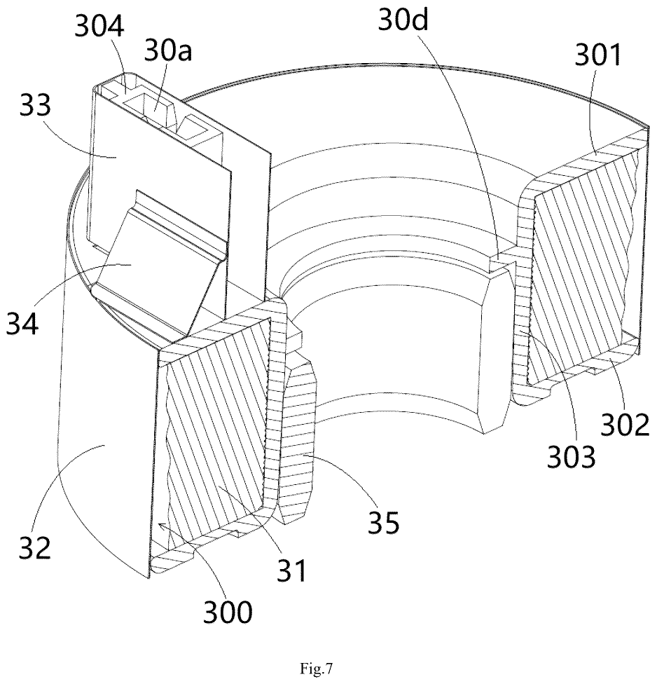

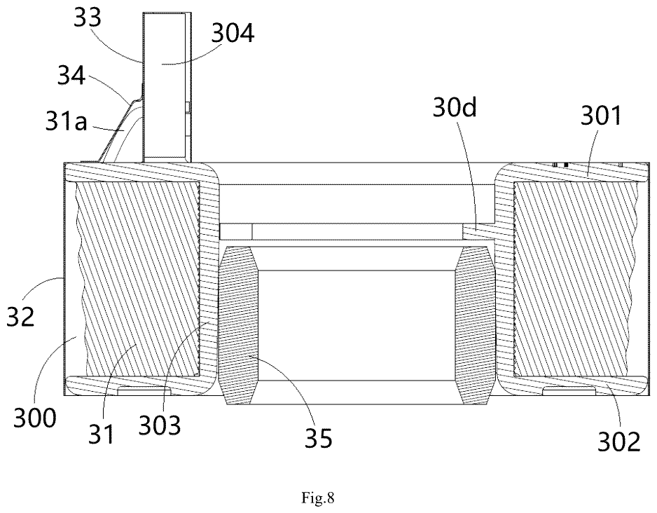

FIG. 1 shows an illustrative perspective view of a relay according to an exemplary embodiment of the present invention. FIG. 2 shows a cross-sectional view of a relay according to an exemplary embodiment of the present invention. FIG. 3 shows an illustrative perspective view of a relay coil assembly 3 according to an exemplary embodiment of the present invention. FIG. 4 shows an illustrative exploded view of relay coil assembly 3 according to an exemplary embodiment of the present invention. FIG. 5 shows an illustrative exploded view of relay coil assembly 3 according to an exemplary embodiment of the present invention. FIG. 6 shows an illustrative exploded view of relay coil assembly 3 according to an exemplary embodiment of the present invention. FIG. 7 shows a cross-sectional view of relay coil assembly 3 according to an exemplary embodiment of the present invention. FIG. 8 shows a plan sectional view of a relay coil assembly 3 according to an exemplary embodiment of the present invention.

As shown in FIGS. 1-8, in an exemplary embodiment of the present invention, a relay coil assembly 3 is disclosed. The relay coil assembly 3 includes a coil skeleton 30, a coil 31, and a first insulation tape 32. The coil skeleton 30 includes an upper flange 301, a lower flange 302, and a cylindrical portion 303 located between the upper flange 301 and the lower flange 302. The coil 31 is wound around the cylindrical portion 303 of the coil skeleton 30. The first insulation tape 32 is wrapped and bonded to the outer peripheral surfaces of the upper flange 301 and the lower flange 302. The coil skeleton 30 is located in the space surrounded by the first insulation tape 32, and the coil 31 is sealed in an annular enclosed space 300 defined by the first insulation tape 32 and the coil skeleton 30.

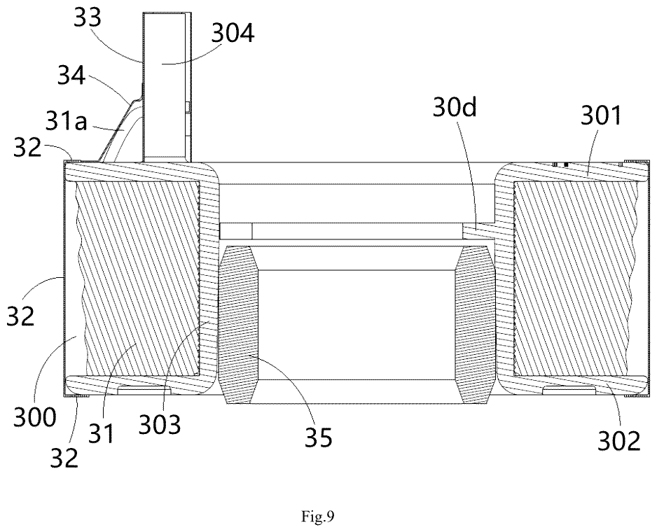

FIG. 9 shows a plan sectional view of a relay coil assembly 3 according to another exemplary embodiment of the present invention. The difference between the relay coil assembly 3 shown in FIG. 9 and the relay coil assembly 3 shown in FIGS. 1-8 is that a portion of the first insulation tape 32 is also bonded to the peripheral portions of the top surface of the upper flange 301 and the bottom surface of the lower flange 302. In this way, the electrical isolation performance can be further improved.

In the illustrated embodiment, the coil skeleton 30 further includes two post parts 304 formed on the top surface of the upper flange 301, in which slots 30a for inserting coil terminals 8 are formed. The two connection ends 31a of the coil 31 respectively extend into the slots 30a of the two post parts 304 for electrical connection with the coil terminals 8 inserted into the slots 30a of the post parts 304.

The relay coil assembly 3 further includes a single second insulation tape 33, which is simultaneously wrapped and bonded to the outer sides of two post parts 304, such that the two post parts 304 are located in the space surrounded by the single second insulation tape 33. However, the present invention is not limited to the illustrated embodiment. For example, in another exemplary embodiment of the present invention, the relay coil assembly further comprises two second insulation tapes 33, which are respectively wrapped and bonded to the outer sides of two post parts 304, such that the post part 304 is located in the space surrounded by the second insulation tape 33.

As shown in FIGS. 1-8, in the illustrated embodiment, a first slit 30c is formed in the upper flange 301, and a second slit 30b connected to the slot 30a is formed in the side wall of the post part 304. The connection end 31a of the coil 31 passes through the upper flange 301 through the first slit 30c and enters into the slot 30 a through the second slit 30 b.

The relay coil assembly 3 further includes a single third insulation tape 34, which is simultaneously adhered to one side of the two post parts 304 and the top surface of the upper flange 301 to cover the exposed portions of the two connection ends 31a of the coil 31. However, the present invention is not limited to the illustrated embodiment. For example, in another exemplary embodiment of the present invention, the relay coil assembly 3 further comprises two third insulation tapes 34, which are respectively adhered to one side of the two post parts 304 and the top surface of the upper flange 301 to respectively cover the exposed portions of the two connection ends 31a of the coil 31.

A radially protruding positioning ring 30d is formed in the cylindrical portion 303 of the coil skeleton 30. The positioning ring 30d is used to axially rest on a positioning flange 61d of a movable magnetic core 61 of the relay to position the movable magnetic core 61 at the initial position. The relay coil assembly 3 further includes a magnetic tube 35, which is inserted and fixed into the lower end of the cylindrical portion 303 of the coil skeleton 30 and located below the positioning ring 30d. The lower end face of the magnetic tube 35 is used for electrical contact with the inner side of the bottom wall of a metal shell 4 of the relay. The coil skeleton 30 is injection molded onto the magnetic tube 35, so that the coil skeleton 30 and the magnetic tube 35 become an integrated piece.

There is a predetermined gap between the first insulation tape 32 and the coil 31, so that the first insulation tape 32 does not come into contact with the coil 31. In this way, the electrical isolation performance can be further improved. For example, it can prevent the problem of the first insulation tape 32 being high-voltage punctured by the metal shell 4 due to pinholes on the enameled wire of the coil.

As shown in FIGS. 1-8, in another exemplary embodiment of the present invention, a relay is disclosed. The relay includes: a metal shell 4, a relay coil assembly 3, and a magnetic plate 5. The relay coil assembly 3 is set into the metal shell 4. The magnetic plate 5 is set in the metal shell 4 and supported on the top surface of the upper flange 301 of the coil skeleton 30. The outer peripheral surface of the magnetic plate 5 is in electrical contact with the inner peripheral surface of the metal shell 4, and the first insulation tape 32 electrically isolates the coil skeleton 30 from the metal shell 4.

In the illustrated embodiment, the relay also includes an outer insulation shell 10. The metal shell 4 is set in the outer insulation shell 10. The metal shell 4 and the outer insulation shell 10 have top openings, and the relay coil assembly 3 is installed into the metal shell 4 through the top openings of the metal shell 4 and the outer insulation shell 10 and supported on the bottom wall of the metal shell 4. The outer insulation shell 10 is injection molded onto the metal shell 4, making the outer insulation shell 10 and the metal shell 4 an integrated piece.

In the illustrated embodiment, the relay further comprises an insulation cover 11, an inner insulation shell 70, and an insulation seat 71. The insulation cover 11 is installed into the top opening of the outer insulation shell 10. The inner insulation shell 70 is located in the upper part of the metal shell 4 and has a bottom opening. The insulation seat 71 is installed in the bottom opening of the inner insulation shell 70 and supported on the top surface of the magnetic plate 5.

The relay further comprises a pair of static terminals 1 and a movable terminal 2. The pair of static terminals 1 are fixed to the insulation cover 11 and extend into the inner insulation shell 70. The movable terminal 2 is arranged in the inner insulation shell 70 in a movable manner. The movable terminal 2 can be moved between a closed position in electrical contact with the pair of static terminals 1 and an open position in electrical separation from the pair of static terminals 1.

The relay further comprises a movable magnetic core 61 and a drive shaft 60. The movable magnetic core 61 is arranged in the cylindrical portion 303 of the coil skeleton 30 in a movable manner. The drive shaft 60 is set in the cylindrical portion 303 of the coil skeleton 30 and passes through the magnetic plate 5 and the insulation seat 71 into the inner insulation shell 70. The movable terminal 2 is installed at the upper end of the drive shaft 60, and the lower end of the drive shaft 60 is fixed to the movable magnetic core 61 to move axially together with the movable magnetic core 61.

The relay further includes a support washer 64, a limit ring 63, and a contact spring 62. The supporting washer 64 is set on the insulation seat 71. The limit ring 63 is fixed to the upper end of the drive shaft 60, used to rest against the top surface of the movable terminal 2. The contact spring 62 is axially compressed between the support washer 64 and the bottom surface of the movable terminal 2, used to apply electrical contact force to the movable terminal 2.

Through holes are respectively formed in the magnetic plate 5 and the insulation seat 71 to allow the drive shaft 60 to pass through, and a protruding ring 71 is formed on the bottom surface of the insulation seat 71, which is inserted and positioned into the through hole of the magnetic plate 5.

The relay further includes a reset spring 65, which is mounted on the drive shaft 60 and axially compressed between the movable magnetic core 61 and the protruding ring 71 of the magnetic plate 5 or the insulation seat 71. When the coil 31 is energized, the drive shaft 60 drives the movable terminal 2 from the open position to the closed position under the action of electromagnetic force. When the coil 31 loses power, the drive shaft 60, under the elastic reset force of reset spring 65, drives the movable terminal 2 to move from the closed position to the open position. When the movable terminal 2 is in the open position, the movable magnetic core is positioned in the initial position.

The relay also includes a pair of coil terminals 8. The pair of coil terminals 8 are respectively inserted into the slots 30a of the two post parts 304 of the coil skeleton 30 and electrically connected to the two connection ends 31a of the coil 31. The upper ends of the pair of static terminals 1 extend from the insulation cover 11 for electrical connection to a high-voltage load circuit, and the upper ends of the pair of coil terminals 8 extend from the insulation cover 11 for electrical connection to a low-voltage control circuit.

The insulation cover 11 has a first electrical isolation wall 11a formed on its top surface, which electrically isolates the coil terminal 8 from the static terminal 1 to increase the creepage distance between the coil terminal 8 and the static terminal 1. In the illustrated embodiment, the insulation cover 11 also has a second electrical isolation wall 11b formed on its top surface, which intersects perpendicularly with the first electrical isolation wall 11a. The second electrical isolation wall 11b electrically isolates the pair of static terminals 1 to increase the creepage distance between them.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A relay coil assembly, comprising:
a coil skeleton having an upper flange, a lower flange, and a cylindrical portion located between the upper flange and the lower flange;
a coil wound around the cylindrical portion of the coil skeleton; and
a first insulation tape wrapped and bonded to the outer peripheral surfaces of the upper flange and the lower flange, the coil skeleton located in a space surrounded by the first insulation tape, and the coil sealed in an annular enclosed space defined by the first insulation tape and the coil skeleton.

2. The relay coil assembly according to claim 1, wherein a portion of the first insulation tape is bonded to the peripheral portion of the top surface of the upper flange and the peripheral portion of the bottom surface of the lower flange.

3. The relay coil assembly according to claim 1, wherein:
the coil skeleton further includes two post parts formed on the top surface of the upper flange, a slot for inserting a coil terminal formed in the post part; and
two connection ends of the coil respectively extend into the slots of the two post parts for electrical connection with the coil terminals inserted into the slots of the post parts.

4. The relay coil assembly according to claim 3, further comprising a single second insulation tape simultaneously wrapped and bonded to the outer sides of the two post parts, so that the two post parts are located in a space surrounded by the single second insulation tape.

5. The relay coil assembly according to claim 3, further comprising two second insulation tapes respectively wrapped and bonded to the outer sides of the two post parts, so that the post part is located in a space surrounded by the second insulation tape.

6. The relay coil assembly according to claim 4, wherein:
a first slit is formed in the upper flange, and a second slit connected to the slot is formed in the side wall of the post part; and
the connection end of the coil passes through the upper flange through the first slit and enters into the slot through the second slit.

7. The relay coil assembly according to claim 6, further comprising a single third insulation tape simultaneously bonded to one side of the two post parts and the top surface of the upper flange to cover the exposed parts of the two connection ends of the coil.

8. The relay coil assembly according to claim 6, further comprising two third insulation tapes respectively bonded onto one side of the two post parts and the top surface of the upper flange to respectively cover the exposed parts of the two connection ends of the coil.

9. The relay coil assembly according to claim 1, wherein a radially protruding positioning ring is formed in the cylindrical portion of the coil skeleton, and is adapted to axially rest on a positioning flange of a movable magnetic core of a relay to position the movable magnetic core at an initial position.

10. The relay coil assembly according to claim 9, further comprising a magnetic tube inserted and fixed into the lower end of the cylindrical portion of the coil skeleton and located below the positioning ring, a lower end face of the magnetic tube is used for electrical contact with an inner side of a bottom wall of a metal shell of the relay.

11. The relay coil assembly according to claim 10, wherein the coil skeleton is injection molded onto the magnetic tube, so that the coil skeleton and the magnetic tube form an integrated piece.

12. The relay coil assembly according to claim 1, wherein a predetermined gap is formed between the first insulation tape and the coil, so that the first insulation tape does not come into contact with the coil.

13. A relay, comprising:
a metal shell;
a relay coil assembly arranged in the metal shell, including:
a coil skeleton having an upper flange, a lower flange, and a cylindrical portion located between the upper flange and the lower flange;
a coil wound around the cylindrical portion of the coil skeleton; and
a first insulation tape wrapped and bonded to the outer peripheral surfaces of the upper flange and the lower flange, the coil skeleton located in a space surrounded by the first insulation tape, and the coil sealed in an annular enclosed space defined by the first insulation tape and the coil skeleton; and
a magnetic plate installed in the metal shell and supported on the top surface of the upper flange of the coil skeleton, the outer peripheral surface of the magnetic plate is in electrical contact with the inner peripheral surface of the metal shell, and the first insulation tape electrically isolates the coil skeleton from the metal shell.

14. The relay according to claim 13, further comprising an outer insulation shell in which the metal shell is arranged, the metal shell and the outer insulation shell having top openings, with the relay coil assembly installed into the metal shell through the top openings of the metal shell and the outer insulation shell and supported on the bottom wall of the metal shell.

15. The relay according to claim 14, wherein the outer insulation shell is injection molded onto the metal shell, such that the outer insulation shell and the metal shell form an integrated piece.

16. The relay according to claim 14, further comprising:
an insulation cover installed into the top opening of the outer insulation shell;
an inner insulation shell provided in the upper part of the metal shell and has a bottom opening; and
an insulation seat installed in the bottom opening of the inner insulation shell and supported on the top surface of the magnetic plate.

17. The relay according to claim 16, further comprising:
a pair of static terminals fixed to the insulation cover and extend into the inner insulation shell; and
a movable terminal arranged in the inner insulation shell in a movable manner, the movable terminal movable between a closed position in electrical contact with the pair of static terminals and an open position in electrical separation from the pair of static terminals.

18. The relay according to claim 17, further comprising:
a movable magnetic core movably provided in the cylindrical portion of the coil skeleton; and
a drive shaft set in the cylindrical portion of the coil skeleton and passing through the magnetic plate and the insulation seat into the inner insulation shell, the movable terminal is installed at the upper end of the drive shaft, and the lower end of the drive shaft is fixed to the movable magnetic core to move axially together with the movable magnetic core.

19. The relay according to claim 18, further comprising:
a support washer set on the insulation seat;
a limit ring fixed to the upper end of the drive shaft for resting against the top surface of the movable terminal; and
a contact spring axially compressed between the support washer and the bottom surface of the movable terminal, and adapted to apply electrical contact force to the movable terminal.

20. The relay according to claim 19, wherein a through hole is formed in the magnetic plate and the insulation seat to allow the drive shaft to pass through, and a protruding ring is formed on the bottom surface of the insulation seat and is inserted and positioned into the through hole of the magnetic plate.

21. The relay according to claim 19, further comprising a reset spring fitted onto the drive shaft and axially compressed between the movable magnetic core and the magnetic plate or the protruding ring of the insulation seat, wherein:
when the coil is energized, the drive shaft drives the movable terminal to move from the open position to the closed position under the action of electromagnetic force; and
when the coil loses power, the drive shaft drives the movable terminal to move from the closed position to the open position under the elastic reset force of the reset spring.

22. The relay according to claim 17, further comprising a pair of coil terminals respectively inserted into the slots of the two post parts of the coil skeleton and electrically connected to two connection ends of the coil, upper ends of the pair of static terminals extend from the insulation cover for electrical connection to a high-voltage load circuit, and upper ends of the pair of coil terminals extends from the insulation cover for electrical connection to a low-voltage control circuit.

23. The relay according to claim 22, wherein the insulation cover has a first electrical isolation wall formed on its top surface, which electrically isolates the coil terminal from the static terminal to increase the creepage distance between the coil terminal and the static terminal.

24. The relay according to claim 23, wherein:
the insulation cover further includes a second electrical isolation wall formed on its top surface, which intersects perpendicularly with the first electrical isolation wall; and
the second electrical isolation wall electrically isolates the pair of static terminals to increase the creepage distance between them.
